(19) United States
(12) Patent Application Publication
(10) Pub. No.: US 2025/0271248 A1
(43) Pub. Date: Aug. 28, 2025

(54) System and Method for Simultaneous Tube Measurement and Assembly

(71) Applicant: Joseph Gambino, Sandy, OR (US)

(72) Inventor: Joseph Gambino, Sandy, OR (US)

(21) Appl. No.: 18/589,068

(22) Filed: Feb. 27, 2024

(51) Int. Cl. G01B 3/56; G01B 3/00; G01B 5/02; G01B 5/213; G01B 5/24; G01D 11/16

(52) U.S. Cl. CPC G01B 3/563; G01B 3/004; G01B 5/02; G01B 5/213; G01B 5/24; G01D 11/16

(57) ABSTRACT

The problem when fabricating structures from pieces requiring bent and straight sections is controlling the straight lengths, bend angles, and rotation between each bend. The very nature of assembling sections of tube into structures introduces a 3-dimensional aspect that needs to be controlled. Applications vary wherein the desired final structure of tubing containing bends needs be coplanar; other times, not. To date there is no device that measures bends, indicating accurate and precise degrees of angle while determining the centerline length of bent section simultaneously, and, planes tangent to the outer circumference of any of the tubes creating the structure. What's more, a device that indicates rotational lines along the straight sections of tube to be fitted with pre-bent sections. Additionally, the device allows for precise bending and fitting measurements to be transcribed onto tube to be bent and cut as per the device's function.

### PRIOR ART

Prior art patent filings related to tube notchers include U.S. Pat. Nos. 2,950,536A, 7,886,565B2, 2,403,420A, and RO136056A0. The complete disclosures of the above patents are herein incorporated by reference for all purposes.

### BACKGROUND OF THE INVENTION

The present disclosure invention relates to precise angular measurement of tube sections to be bent, the overall length of bent section, and rotational aspects to precisely fit the bent section between two lengths of straight tube, and a means to monitor the trueness of a bend to a fixed radius. The degree of rotation about a fitted straight section wherein sections of straight tube may or may not lie in the same plane depending on the needs of the fabricator can be precisely controlled.

Protractors are devices that measure angles. The disclosed device allows separate sections of material (such as tubes or rods, or even other non-cylindrical shaped like square tubes, hollow or solid) to be measured for specific bend to angles. Having a set of precise measurements to transcribe onto tubes to be joined, or bent onto a piece of sufficient length is essential for efficient and precise fitting of a fabricated structure. When sections of tube containing straight and bends segments are assembled, measuring of the angular degree of the bend is critical to fitting the final structure with its intended application. Additionally, the rotation of the bent sections about the straight sections is equally important for this determines whether or not the resultant structure is coplanar (or non-coplanar) as intended by the final design.

Existing protractors do not fully take into account the relationship between the alignment of center of the bent tube sections with respect to the centerline of the adjoining sections and their degree of rotation. The alignment of the respective centerlines of the bent sections to the centerline of the straight sections in the final fabrication must be in complete agreement for accurate fitting of the final structure to its intended function. Furthermore, current protractors do not offer a means to be affixed to affordable and rigid structures to extend their size and be utilized to visualize or prototype a structure in true 1:1 scale.

Consequently, a need exists that enables fabricators to be able to measure and transcribe measurements onto pieces of bent and straight sections that can be accurately and precisely joined to adhere to the specifications of the intended design.

An additional requisite of joining bent and straight tube sections is to control the length of bent sections. The separation between any two given lengths of straight tube has a specific distance between them, and to transcribe this distance onto a bent section is crucial to maintain the overall length of the fabricated structure. Different measuring mechanisms have been proposed, however none to date satisfy the requirement of degree of bend, final length of bent section and degree of rotation while adhering to the final specifications of the resultant structure.

### BRIEF DESCRIPTION OF THE DRAWINGS

FIG. 1. Shows a frontal view of the disclosed device where the measurement graduations may clearly be seen. The main scribing features are present, namely, degrees for bend angle, linear measurements for length of bend down the centerline, degree increments for scribing rotations, the formula to convert degrees to lengths of bend.

FIG. 2. Depicts a rotated view from FIG. 1 highlighting the spacing of the functional parts on the disclosed device. As seen in the figure, the part of the device that checks for trueness to the radius is set apart from the “A” face.

FIG. 3. Illustrates a 3-dimensional view of the device allowing the viewer a perspective view of the disclosed device. This figure highlights the part of the device that checks the trueness of the bend to the radius along with the aforementioned inscriptions for transcribing measurements.

FIG. 4. Illustrates an example of rotations from e adjoining straight sections, separated by 2 of the disclosed devices device set at a certain bend angle wherein a front, side and back view are shown for clarity.

FIG. 5. Depicts an arbitrary rotation angle from one straight section to another wherein the angle of rotation is made plain by the dashed line.

### SUMMARY OF THE INVENTION

The work presented here intends to make plain the apparatus that is capable of measuring and transcribing 4 different measurements: the angle of bend to a section of tube; the length of bend of section of tube; and the degree of rotation between multiple bends in a single part, and the trueness of the bend to a fixed radius. Further, feedstocks of different dimensions and geometry may accept transcription of these 4 aforementioned measurements.

### Background

The apparatus that is capable of measuring and transcribing measurements (heretofore referenced as the prototractor will now be described. The prototractor discussed herein function to transcribe angular and rotational measurements, to feedstocks such as tubes or rods, or even other non-cylindrical shaped like square tubes. Additionally, or alternatively to tubular feedstocks, the prototractor are configured to transcribe measurements in bars, rods, plates, and structural members. For brevity, objects and feedstocks such as feedstocks such as tubes or rods, other non-cylindrical shaped like square tubes, ether hollow or solid, will simply be referred to as tubes. The prototractor performs these functions while simultaneously serving as a 1:1 scale model/prototype of the desired final structure or fabrication.

The reader will appreciate from the figures and description below that the presently disclosed prototractor addresses many of the shortcomings of conventional tube bending measurements. For example, the prototractor described herein provide increased capabilities to position the section of tube to be bent relative to the feedstock. In addition to allowing for the prototractor to scribe angular measurements relative to the feedstock, the present prototractor also allows for rotational measurements between bends in a given feedstock. The prototractor also allows a bend to be monitored to the trueness of any given radius of a semicircle. The effectiveness of the prototractor described herein allows the fabricator precise and accurate measurements for quick fabrications of the desired structures.

### Contextual Details

Ancillary features relevant to the prototractor described herein will first be described to provide context and to aid the discussion of the ability of the prototractor to transcribe angular and rotational measurements onto a tube.

### DETAILED DESCRIPTION OF THE INVENTION

The disclosed protractor mechanism is better understood through a close examination of the figures and accompanying descriptions herein. The examples provided intend to exemplify certain examples of the disclosed device but are not considered an exhaustive description, for many variations of the disclosed device not described here apply.

Those skilled in the art will understand that many variations, alterations, and modifications of the examples provided herein may occur without a departing from the scope of the work presented here. The variations referred to here will not be displayed, discussed or illustrated for the sake of brevity.

### Feedstock

The feedstock on which the protractor transcribes measurements described herein may be any feedstock suitable for being scribed with length, bend and rotation indications. In the examples shown in the figures, the feedstock is hollow cylindrical tube. Additionally, or alternatively to tubular feedstocks, the feedstock may be a bar, rod, plate, or structural member. Heretofore, all material types being cut will be referred to as “tube”, “tubing”, or “feedstock”. In some of the disclosed figures, the feedstock is represented as a hollow cylindrical shape.

### Protractor Device

With reference to the figures, the protractor device will now be described. The protractor device discussed herein functions to provide transcriptions of three sets of measurements to tubular sections: length of bend; degree of bend, rotational deviances. Measurements made be transcribed onto sectional pieces then fitted together or one continuous piece of tube. Additionally, or alternatively to tubular feedstocks, the protractor device is configured to form transcribed measurements in bars, rods, plates, and structural members.

### Desired Bend

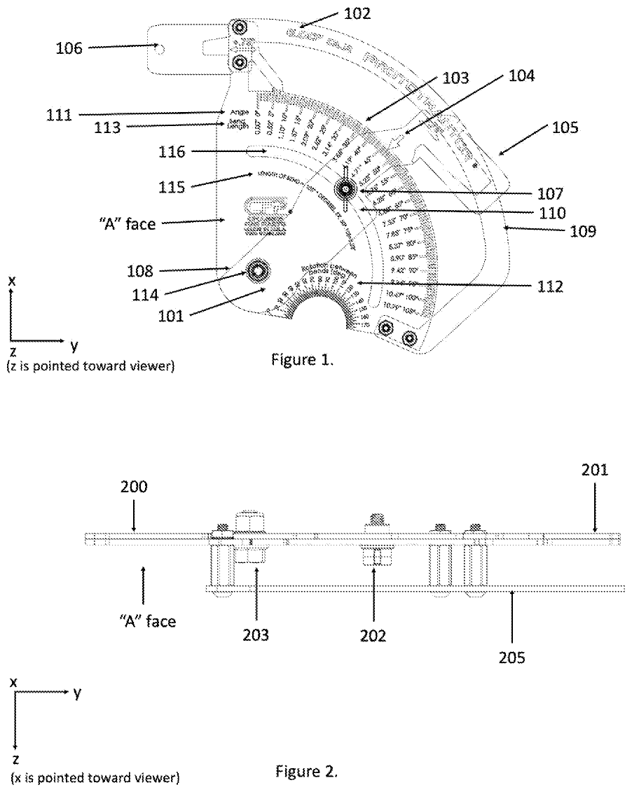

The protractor device is designed to have different radii to accommodate varying size of the tube to be bent. In general, the larger the diameter of the tube, the larger the radii of the prototractor deployed. FIG. 1. 102 illustrates a device to accommodate a 6″ bend radius. The desired bends in the feedstock may or may not vary in its size and position with respect to the rest of the piece of feedstock. There may be more than one bend in any given piece of feedstock.

### Desired Rotation

Additionally, the protractor device is designed to accept tubing of various diameters to scribe rotations from one bend to another. There are unlimited bends and rotations that any tube can receive within the physical limitations of the tube itself. In general, the larger the diameter of the tube, the larger the diameter of the scribing mechanism to accommodate the respective tubing. Rotational markings may or may not vary in its size and position with respect to the rest of the piece of feedstock. There may be more than one rotation in any given piece of feedstock. To measure rotation, a user will mark where the bend plane (the “A face” in the figures) intersects the terminal edge of the tubing installed on the prototractor. These lines will be scribed down the length of the tubing. If the lines are colinear, the bends are coplanar. If the lines have a space between them, the angle of rotation between the 2 bend planes is easily measured with the rotation gauge, [112].

### Trueness to the Radius of a Semicircle

The prototractor exhibits a feature that allows the arc of bent tube to be measured to the arc of a semicircle of radius dictated by the device. This feature allows the fabricator to confirm that the intended radius of the semicircle in question is adhered to, and that said radius is true to the intended design. Should deviations from the radius or environmental interferences occur, the device makes it plain that errors have occurred and the bend is not true to the arc it is modeled after through the device's measurement. Inexactness to the intended end result is made plain to the fabricator without any measurement through this feature.

FIG. 1. Displays the prototractor illustrating the “A” face of the device wherein the graduations for angular measurements, 111, length measurements, 113, and rotational measurements, 112, are indicated. 110, 105, and 104 are all coplanar to 108, which is directly below the A face. Indicated on 108 is 104, which indicates the degree of bend and the centerline length of section bent (111 and 113, respectively). 109 resides in front of the A face establishing a circumferential reference line which allows the fabricator to keep the bend true to the radius. 109 is positioned in front of the A face such that it is a suitable distance in front of the A face to accommodate the diameter of the tube being marked. 107 is an adjustable wing nut to mark for the respective angle of measure that requires no tools by affixing a lever to a screw with a nut rotationally affixed 108.

FIG. 1. 114 marks the pivot point of 108. Feature 108 makes use of a pivot about the center of rotation using hardware included but not limited to: rivets, springs, compressible washers, compression fittings, low friction metallic or plastic washers with lock-in-place hardware like nylon insert nuts, to apply controlled friction for operator comfort and safety while moving the angle between components. The “A” face can be one or multiple inscribed surfaces, stacked surfaces, or coplanar surfaces in which one or more multiple parts may slide past one another, fit into one another, or be conjoined in a coplanar fashion, with one or more attachment means as shown in 107. Multiple parts may be attached in a similar manner in which they slide past each other, fit within one another, and/or are coplanar, being affixed thought the requisite number of attachment means. Multiple inscribed parts together would indicate the rotation to the desired angle, remaining true to the radius governed by the slot 116 allowing the radius to change.

The adjoining tube, pre and post bend, is fitted on the extremities 105 and 106 which mark the end points of the bend. 105 and 106 accept tube fitting to the diameter of the tube. Lengths of tube to be bent that do not fall directly on any graduations, 103, have the formula shown, 115, to calculate the exact centerline length of any bend.

FIG. 2. depicts the prototractor at a 90-degree rotation about the y axis from FIG. 1. 200 and 201 illustrated the tabs that accept the straight tube. The adjustable wing nut allowing the change of measured degree is shown in 202. FIG. 2, 203 is where the radius of the respective bends is defined from the center of the circle to the centerline of the tube being bent. The guide to keep the bend true to the radius is indicated in FIG. 2, 205.

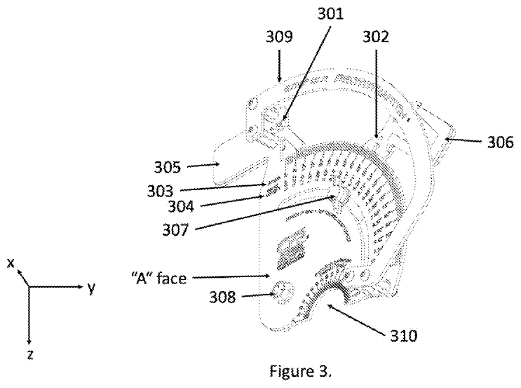

Shown in FIG. 3, 301 is an inscription that indicates the centerline of the tube while simultaneously defining the end of the radius of the semicircle of the bend. Additionally, in this embodiment, 301 accommodates 0.75″ of unbent section at the ends of the bent section. 301 serves to ensure an end section is perpendicular to the centerline of the tube, and thusly, perpendicular to the centerline of the adjoining tube. Maintaining the ends of the bends perpendicular to the centerline allows for sections to be joined with consistent and flush contact. The degree and length indicator are shown as 302, whereas the definition of the measurements is indicated by markings 303 and 304, respectively. Receptors for straight lengths of tube adjoining, or to be adjoined to the bent section are shown as 305 and 306. The angle and length adjustment screw in this embodiment may be seen at 307 in FIG. 3. The pivot point defining the beginning of the radius of the bend from the center of the circular section is show as 308. The guide to maintain truth to the radius is shown as 309. The rotational degree desired by any given design is seen in FIG. 3 at 310. This enables the fabricator precise and accurate control over rotations between bend and segments of tube.

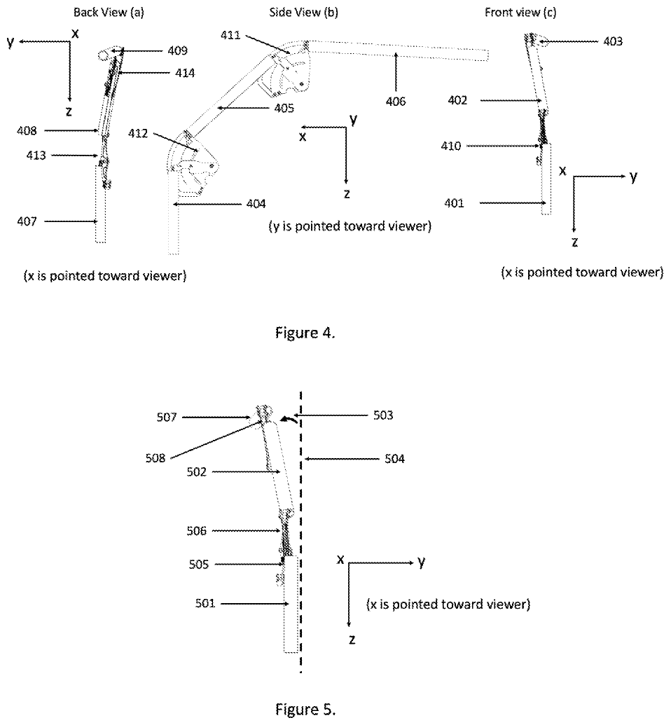

FIG. 4. Illustrates an example of rotations about multiple devices shown in FIG. 4(a) wherein 413 and 414 represent one embodiment of the disclosed device where rotations about straight sections 407, 408 and 409 are established from measurements taken from the disclosed device. FIG. 4. (b) is a side view of the same hardware shown in FIG. 4. (a), rotated 90 degrees. FIG. 4. (c) is the same embodiment as FIG. 4. (a) and (b) rotated 90 degrees from 4(b). The same rotations of straight tube about the disclosed device are depicted.

FIG. 5. Illustrates a rotation about the device, 506, from one straight tube, 501, to the next, 502 with reference line to highlight rotation, 504. 503 represents the rotation in the xz plane shown in the figure. However, this is not a 2-dimensional object, it is 3 dimensional simply illustrating the rotation as seen from the xz plane. Another rotation is illustrated about straight section 502 wherein another disclosed device is deployed to rotate straight section 507 from 502.

1. A device intended to measure angles, lengths and rotations for tube sections to be bent and fitted between straight sections, whole piece sections, and/or onto preexisting structures:
a. The measurement device allows the bent pieces to fit together between lengths of straight tube with a specific desired distance;
b. Wherein a rotation of the straight section between bent sections may be marked by fitting the straight section of tube into the device to transcribe the angle of rotation;
c. When multiple bends are desired which require bending planes in multi-bend parts, fitting straight sections with intentional lengths onto the tabs to transcribe planar measurements of the straight lines, planes between the angles made by the bent sections may be accurately and precisely controlled;
d. Wherein the device in #1 has a structural radial feature that maintains the bend true to any given radius over the course of the arc of the circle made from the bend, establishing instant confirmation of the trueness of the bend to the radius of the given device;
e. Where the device in #1 has one or more pivot lock(s) to fix the angle setting that requires no tools by affixing a lever to a screw with a nut rotationally affixed to the other part;
f. Where the device in #1 has a shape to transcribe rotational measurements around the pipe to accurately determine rotation between multiple devices to accurately determine rotation between an unlimited number of bending planes relative to the adjacent bending planes;
g. Where the device makes use of a pivot about its center of rotation using hardware (such as but not limited to: springs, compressible washers, or low friction metallic or plastic washers with lock-in-place hardware like nylon insert nuts) to apply controlled friction for operator comfort and safety while moving the angle between components;
h. Where the device has an intentional offset on both ends of the bend that are unbent tube of known length from the arc of the bend, yielding the ends of the bend perpendicular to the centerline of both the bent and straight sections considered so that the operator can easily calculate the length the space in between the bent sections of tube;
i. Wherein the device determines the centerline of the tube by placing tube onto the tabs where the straight offset indicator appears;
j. Wherein the device in #1 utilizes affixed plates above and below the pivoting members to make the members co-planar and equal in thickness to allow multiple devices to be perfectly coplanar.

2. Where the device in #1 has markings along its angle measurement surface that allow the simultaneous measure of length of bend down the centerline of tube along with the degree of bend:
a. Where the device in #1 has printed or otherwise marked on it the formulae to calculate the values in #6 to enable to user to easily determine values not specifically pre-marked on the device already;
b. Wherein the device accurately shows the length of material along the centerline in the bend based on the degrees being bent based on the circumference of a circle matching the size of the device and the portion of the circle in use (angle).

3. The face containing the inscribed graduations for measurements of 3 types can be one or multiple inscribed surfaces, stacked surfaces, or coplanar surfaces in which one or more multiple parts may slide past one another, fit into one another, or be conjoined in a coplanar fashion, with one or more attachment means. Multiple parts with any one, or all of the graduations of rotation, length and/or rotational indications may be attached by means of slide past each other, fit within one another, and/or are coplanar, being affixed thought the requisite number of attachment means may be indicated on one or all of the separate parts comprising the device. Multiple inscribed parts together would indicate the rotation to the desired angle, length of bend, and degree of bend, and, truth to the radius governed by affixed guides of suitable radius.
